(19) United States
(12) Patent Application Publication
(10) Pub. No.: US 2026/0079434 A1
(43) Pub. Date: Mar. 19, 2026

(54) IMAGE FORMING APPARATUS CAPABLE OF PREVENTING OCCURRENCE OF PRINTING DEFECTS CAUSED BY OCCURRENCE OF SHAKING OR ACCELERATION CAUSED BY MOVEMENT OF THE IMAGE FORMING APPARATUS, CONTROL METHOD FOR IMAGE FORMING APPARATUS, AND STORAGE MEDIUM

(71) Applicant: CANON KABUSHIKI KAISHA, Tokyo (JP)

(72) Inventor: TAKAAKI MIYATA, Ibaraki (JP)

(21) Appl. No.: 19/317,303

(22) Filed: Sep. 3, 2025

(30) Foreign Application Priority Data
Sep. 18, 2024 (JP) 2024-160790

(51) Int. Cl. G03G 15/00; G03G 21/16

(52) U.S. Cl. CPC G03G 15/5016; G03G 21/1619; G03G 2221/1681

(57) ABSTRACT

A mechanism capable of preventing the occurrence of printing defects caused by the occurrence of shaking or acceleration caused by the movement of an image forming apparatus is provided. An image forming apparatus, which is capable of being moved by a moving mechanism to a destination designated by a user, includes at least one processor, and a memory coupled to the processor storing instructions that, when executed by the processor, cause the processor to function as a printing unit that executes a print processing that generates a printed matter, a retaining unit that retains a setting set by the user, the setting indicating whether or not to permit execution of the print processing at a predetermined timing related to movement by the moving mechanism, and a control unit that controls the execution of the print processing based on the setting.

### BACKGROUND

### Field of the Technology

The present disclosure relates to an image forming apparatus, a control method for the image forming apparatus, and a storage medium.

### Description of the Related Art

There is known an apparatus that performs a print processing to output a printed matter, moves to a moving destination designated by a user, and delivers the printed matter. One example of such an apparatus is a self-traveling type image forming apparatus equipped with a moving means (a moving mechanism). The self-traveling type image forming apparatus receives, from a computer, print data and information on a delivery destination, and identifies location information of the delivery destination by referring to map information. The self-traveling type image forming apparatus plans a travel route that enables efficient travel to a plurality of delivery destinations, and performs the control of the moving means based on the plan (for example, see Japanese Laid-Open Patent Publication (kokai) No. 2001-125646). In addition, the self-traveling type image forming apparatus includes an obstacle sensor, and travels while avoiding obstacles detected by the obstacle sensor. As a result, it is possible for the self-traveling type image forming apparatus to efficiently deliver the printed matter to a desired location while avoiding obstacles.

In order to be able to provide a user with a printed matter promptly when the self-traveling type image forming apparatus arrives at the delivery destination, the self-traveling type image forming apparatus performs the print processing, for example, while the self-traveling type image forming apparatus is moving to the delivery destination. However, if the print processing is performed while the self-traveling type image forming apparatus is moving to the delivery destination, there is a concern that printing defects such as line streaks and blurring may occur due to the occurrence of shaking or acceleration caused by the movement (traveling) of the self-traveling type image forming apparatus.

### SUMMARY

The present disclosure provides a mechanism capable of preventing the occurrence of printing defects caused by the occurrence of shaking or acceleration caused by the movement of an image forming apparatus.

Accordingly, an aspect of the present disclosure provides an image forming apparatus that is capable of being moved by a moving mechanism to a destination designated by a user, the image forming apparatus comprising at least one processor, and a memory coupled to the processor storing instructions that, when executed by the processor, cause the processor to function as a printing unit that executes a print processing that generates a printed matter, a retaining unit that retains a setting set by the user, the setting indicating whether or not to permit execution of the print processing at a predetermined timing related to movement by the moving mechanism, and a control unit that controls the execution of the print processing based on the setting.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates an example of a configuration of a system, which includes an image forming apparatus according to an embodiment of the present disclosure.

FIG. 2A is a block diagram that illustrates an example of a functional configuration of the image forming apparatus shown in FIG. 1, and FIG. 2B is a block diagram that illustrates an example of a functional configuration of a station apparatus shown in FIG. 1.

FIG. 3 is a block diagram that schematically illustrates a hardware configuration of the image forming apparatus shown in FIG. 1.

FIG. 4 is a schematic diagram that illustrates an example of an operation direction of the image forming apparatus shown in FIG. 1.

FIG. 5 is a block diagram that schematically illustrates a hardware configuration of a user terminal shown in FIG. 1.

FIG. 6A, FIG. 6B, and FIG. 6C are sequence diagrams that illustrate the procedure of a printing operation performed by the image forming apparatus shown in FIG. 1 in accordance with a print instruction received from the user terminal shown in FIG. 1.

FIG. 7A, FIG. 7B, and FIG. 7C are diagrams that illustrate examples of a setting screen displayed on an operation unit shown in FIG. 3.

FIG. 8 is a flowchart that illustrates the procedure of a moving print processing executed by the image forming apparatus shown in FIG. 1.

FIG. 9 is a diagram that illustrates an example of map information stored in a storage shown in FIG. 3.

FIG. 10 is a diagram that illustrates an example of a selection screen displayed on the operation unit shown in FIG. 3.

### DESCRIPTION OF THE EMBODIMENTS

The present disclosure will now be described in detail below with reference to the accompanying drawings showing embodiments thereof.

Hereinafter, an embodiment of the present disclosure will be specifically described with reference to the accompanying drawings. It should be noted that the scope of the present disclosure is not limited to configurations described in the embodiment. As long as the same effect is obtained, modifications such as replacing a part of the configuration or a part of the processing with an equivalent or omitting a part of the configuration or a part of the processing may be made.

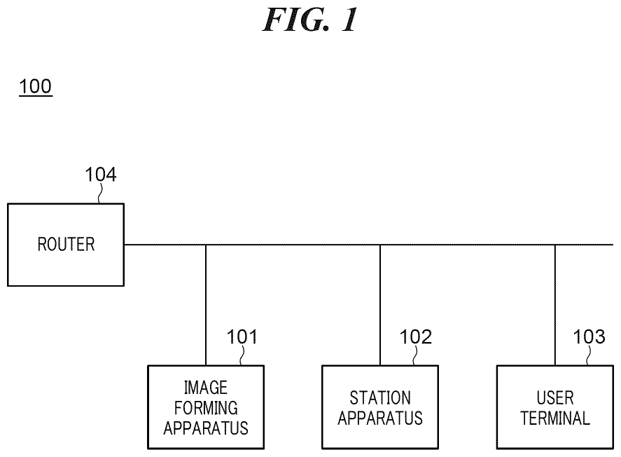

FIG. 1 is a block diagram that illustrates an example of a configuration of a system 100, which includes an image forming apparatus 101 according to the embodiment of the present disclosure. As shown in FIG. 1, the system 100 includes the image forming apparatus 101, a station apparatus 102, and a user terminal 103. The image forming apparatus 101, the station apparatus 102, and the user terminal 103 are connected to the same network environment via a router 104. It should be noted that in the present embodiment, the system 100 is configured to include one image forming apparatus 101, one station apparatus 102, and one user terminal 103, but the configuration of the system 100 is not limited to this configuration. For example, the system 100 may be configured to include a plurality of image forming apparatuses 101, a plurality of station apparatuses 102, and a plurality of user terminals 103.

In the system 100, a print instruction is transmitted from the user terminal 103 that has been operated by a user to the image forming apparatus 101. The image forming apparatus 101 is a self-traveling type image forming apparatus, executes a print processing in accordance with the received print instruction, and also moves to a delivery destination that is indicated by delivery destination information included in the print instruction. It should be noted that the system 100 may be configured so that print job information is transmitted from the user terminal 103 that has been operated by the user to the station apparatus 102, and a print instruction based on this print job information is transmitted from the station apparatus 102 to the image forming apparatus 101.

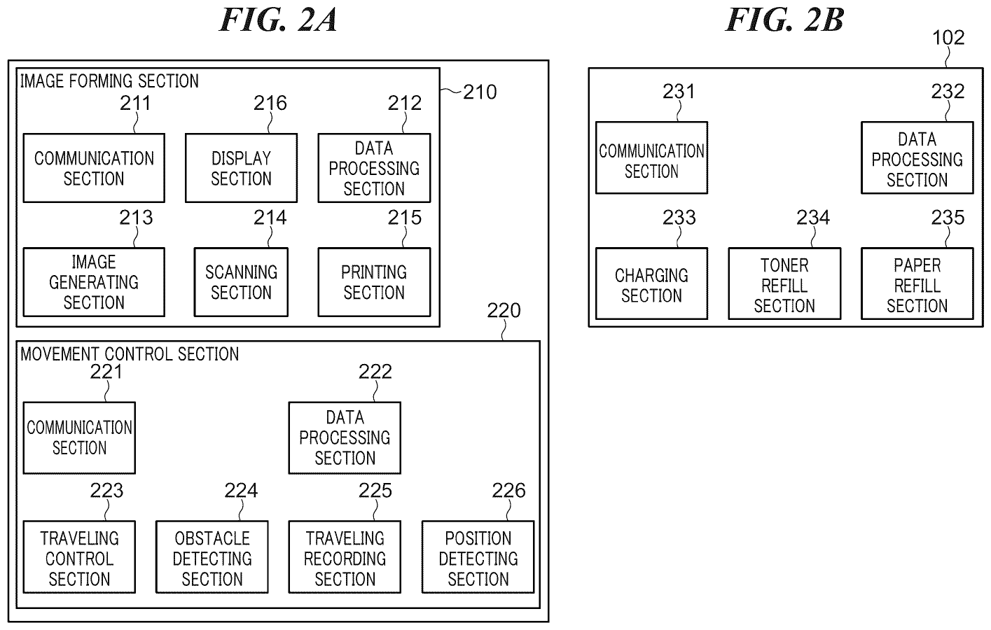

FIG. 2A is a block diagram that illustrates an example of a functional configuration of the image forming apparatus 101 shown in FIG. 1, and FIG. 2B is a block diagram that illustrates an example of a functional configuration of the station apparatus 102 shown in FIG. 1. FIG. 2A illustrates an example of the functional configuration of the image forming apparatus 101.

As shown in FIG. 2A, the image forming apparatus 101 includes, as its functions, an image forming section 210 and a movement control section 220. The image forming section 210 includes a communication section 211, a data processing section 212, an image generating section 213, a scanning section 214, a printing section 215, and a display section 216.

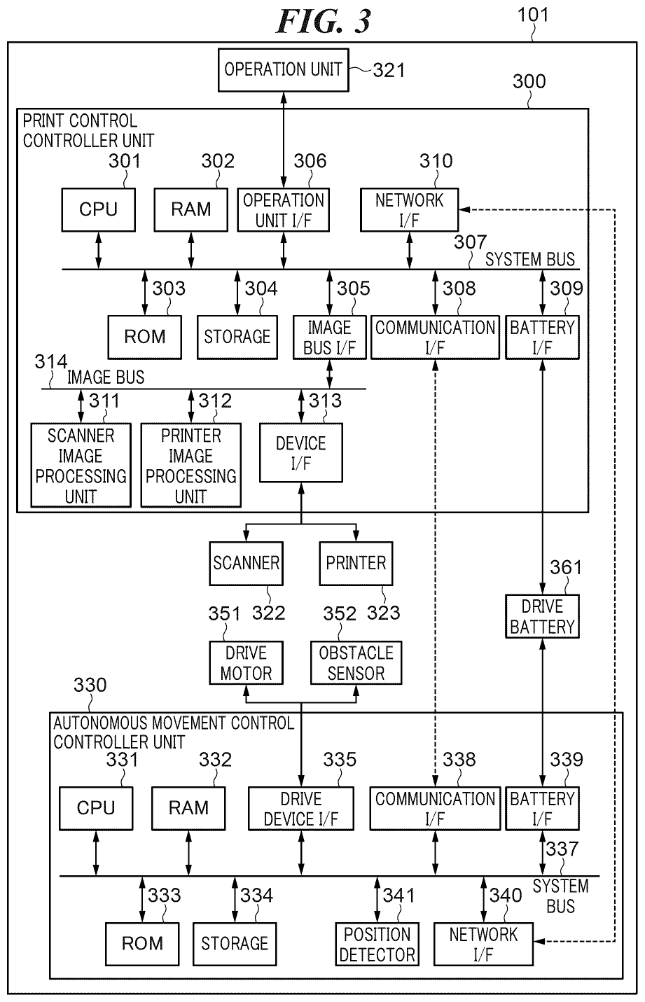

The communication section 211 communicates with the user terminal 103 to perform data exchange. The data processing section 212 performs data processing related to each function. The image generating section 213 performs image rendering of print data and generating image data based on scanned information. The scanning section 214 performs scanning an image printed on paper, and outputs the scanned information, which has been obtained by the scanning, to the image generating section 213. The printing section 215 prints and outputs the image, which has been rendered by the image generating section 213, on a paper medium or the like. The display section 216 accepts operations performed by the user and performs the display of various kinds of screens. These functions of the image forming section 210 are realized by a central processing unit (a CPU) 301 shown in FIG. 3, which will be described below, executing a program that has been loaded into a random access memory (a RAM) 302.

The movement control section 220 includes a communication section 221, a data processing section 222, a traveling control section 223, an obstacle detecting section 224, a traveling recording section 225, and a position detecting section 226. The communication section 221 communicates with the station apparatus 102 to exchange position and map information and the like. The data processing section 222 performs data processing related to each function. The traveling control section 223 controls a drive motor based on obstacle information that has been obtained by the obstacle detecting section 224 and the position and map information and the like that have been obtained from the station apparatus 102 by the communication section 221 to perform autonomous traveling. The obstacle detecting section 224 obtains the obstacle information indicating obstacles detected by an obstacle sensor 352 shown in FIG. 3, which will be described below. The traveling recording section 225 manages information about a travel route along which the image forming apparatus 101 travels. The position detecting section 226 detects the current position of the image forming apparatus 101. These functions of the movement control section 220 are realized by a CPU 331 shown in FIG. 3, which will be described below, executing a program that has been loaded into a RAM 332.

FIG. 2B illustrates an example of the functional configuration of the station apparatus 102. As shown in FIG. 2B, the station apparatus 102 includes, as its functions, a communication section 231, a data processing section 232, a charging section 233, a toner refill section 234, and a paper refill section 235. The communication section 231 communicates with the image forming apparatus 101 to perform data exchange. The data processing section 232 performs data processing related to each function. The charging section 233 performs charging of the image forming apparatus 101 that is connected to the station apparatus 102. The toner refill section 234 performs refilling of toner to be used for printing with respect to the image forming apparatus 101 that is connected to the station apparatus 102. The paper refill section 235 performs refilling of paper to be used for printing with respect to the image forming apparatus 101 that is connected to the station apparatus 102. These functions of the station apparatus 102 are controlled by a CPU (not shown) included in the station apparatus 102.

FIG. 3 is a block diagram that schematically illustrates a hardware configuration of the image forming apparatus 101 shown in FIG. 1. As shown in FIG. 3, the image forming apparatus 101 includes a print control controller unit 300, an operation unit 321, a scanner 322, a printer 323, an autonomous movement control controller unit 330, a drive motor 351, an obstacle sensor 352, and a drive battery 361.

The scanner 322 which is an image input device, the printer 323 which is an image output device, and the operation unit 321 are connected to the print control controller unit 300. For example, the print control controller unit 300 performs a control for realizing a copy function in which image data that has been read by the scanner 322 is printed out by the printer 323.

The drive motor 351, which is a moving mechanism, and the obstacle sensor 352 for autonomous control are connected to the autonomous movement control controller unit 330. For example, the autonomous movement control controller unit 330 controls the drive motor 351 based on the obstacle information indicating the obstacles detected by the obstacle sensor 352, and performs autonomous movement control to automatically avoid the obstacles.

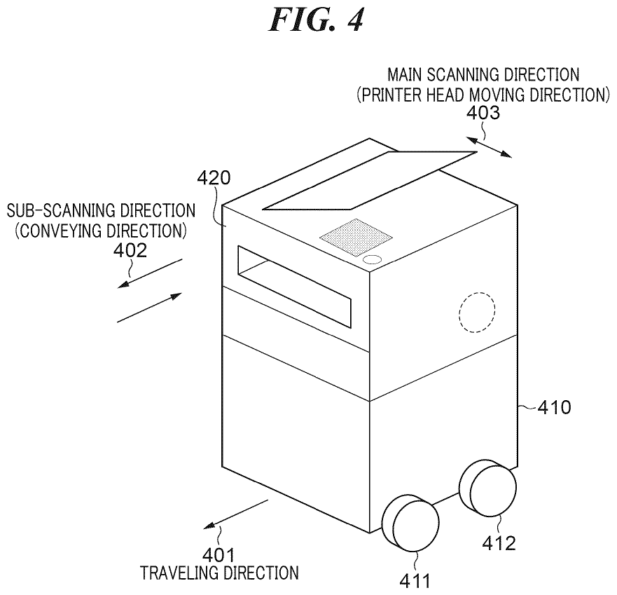

The print control controller unit 300 is a controller unit that controls an image forming mechanism 420 shown in FIG. 4, which will be described below. The print control controller unit 300 includes the CPU 301, the RAM 302, a read only memory (a ROM) 303, a storage 304, an image bus I/F 305, an operation unit I/F 306, a communication I/F 308, a battery I/F 309, and a network I/F 310. The CPU 301, the RAM 302, the ROM 303, the storage 304, the image bus I/F 305, the operation unit I/F 306, the communication I/F 308, the battery I/F 309, and the network I/F 310 are connected to each other via a system bus 307. The print control controller unit 300 further includes a scanner image processing unit 311, a printer image processing unit 312, and a device I/F 313.

The CPU 301 starts up an operating system (an OS) by a boot program that has been stored in the ROM 303. The CPU 301 executes programs that have been stored in the storage 304 on this OS to execute various kinds of processing. The RAM 302 is used as a working area for the CPU 301. The RAM 302 is also used as an image memory area for temporarily storing image data. The storage 304 stores programs and image data.

The operation unit I/F 306 is an interface with the operation unit 321 that includes a touch panel, and outputs, to the operation unit 321, image data to be displayed on the operation unit 321. In addition, the operation unit I/F 306 sends information that has been inputted by the user via the operation unit 321 to the CPU 301. The network I/F 310 is an interface for connecting the image forming apparatus 101 to a local area network (a LAN). The battery I/F 309 is an interface with the drive battery 361 that serves as the operating power source for the scanner 322 and the printer 323. The battery I/F 309 outputs a power usage request and the like that are associated with the execution of a print job to the drive battery 361, and sends remaining battery charge information and the like to the CPU 301. The communication I/F 308 is a communication interface with other devices and controllers, and in the present embodiment, the communication I/F 308 communicates with the autonomous movement control controller unit 330.

The image bus I/F 305 is a bus bridge, which connects the system bus 307 and an image bus 314 that transfers image data at high speed, and converts the data format. The image bus 314 is configured by a peripheral component interconnect bus (a PCI bus), IEEE1394, or the like. The device I/F 313, the scanner image processing unit 311, and the printer image processing unit 312 are provided on the image bus 314. The scanner 322 and the printer 323 are connected to the device I/F 313, and the device I/F 313 performs synchronous/asynchronous conversion of image data. The scanner image processing unit 311 performs processes such as correction, processing, and editing with respect to image data generated by the scanner 322. The printer image processing unit 312 performs processes such as correction and resolution conversion, which correspond to the functions of the printer 323 with respect to image data to be inputted into the printer 323.

The autonomous movement control controller unit 330 is a controller unit that controls a traveling drive mechanism 410 shown in FIG. 4, which will be described below. The autonomous movement control controller unit 330 includes the CPU 331, the RAM 332, a ROM 333, a storage 334, a drive device I/F 335, a communication I/F 338, a battery I/F 339, a network I/F 340, and a position detector 341. The CPU 331, the RAM 332, the ROM 333, the storage 334, the drive device I/F 335, the communication I/F 338, the battery I/F 339, the network I/F 340, and the position detector 341 are connected to each other via a system bus 337.

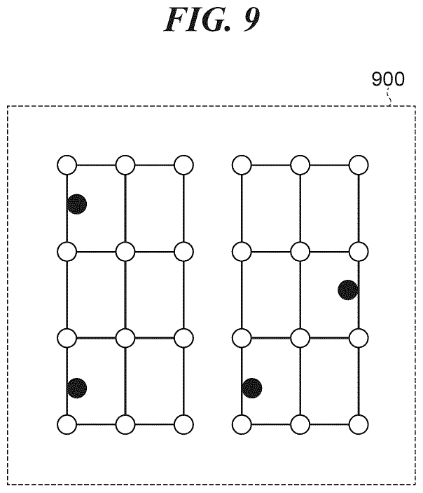

The CPU 331 starts up an OS by a boot program that has been stored in the ROM 333. The CPU 331 executes various kinds of processing by executing programs that have been stored in the storage 334 on this OS. The RAM 332 is used as a working area for the CPU 331. The RAM 332 is also used as a memory area for temporarily storing position information of the image forming apparatus 101 and error messages. The storage 334 stores programs, map information 900 shown in FIG. 9 (described below), etc.

The network I/F 340 is an interface for connecting the image forming apparatus 101 to the LAN. The battery I/F 339 is an interface with the drive battery 361 that serves as the operating power source for the drive motor 351. The battery I/F 339 outputs a power usage request and the like that are associated with the movement of the image forming apparatus 101 to the drive battery 361, and sends remaining battery charge information and the like to the CPU 331. The position detector 341 is specifically a device for detecting a position, such as a GPS, and detects the current position of the image forming apparatus 101. The communication I/F 338 is a communication interface with other devices and controllers, and in the present embodiment, the communication I/F 308 communicates with the print control controller unit 300.

The drive motor 351 and the obstacle sensor 352 are connected to the drive device I/F 335. For example, the drive device I/F 335 outputs a control instruction to the drive motor 351 and sends the obstacle information indicating the obstacles detected by the obstacle sensor 352 to the CPU 331.

It should be noted that in the present embodiment, the print control controller unit 300 and the autonomous movement control controller unit 330 are configured as independent units, but the print control controller unit 300 and the autonomous movement control controller unit 330 may be configured to share their CPUs, RAMs, ROMs, storages, and the like.

In addition, in the present embodiment, a configuration is described in which a communication path between the print control controller unit 300 and the autonomous movement control controller unit 330 uses the communication I/F 308 and communication I/F 338, which are dedicated I/Fs, but the present disclosure is not limited to this configuration. For example, a configuration may be adopted in which the network I/F 310 and the network I/F 340 are used as the communication path between the print control controller unit 300 and the autonomous movement control controller unit 330 to perform communication via a network.

In addition, in the present embodiment, a configuration is described in which the drive battery 361 is controlled by the battery I/F 309 of the print control controller unit 300 and the battery I/F 339 of the autonomous movement control controller unit 330, but a configuration may be adopted in which the drive battery 361 is controlled by only one of the battery I/F 309 and the battery I/F 339. As an example, a configuration in which the drive battery 361 is controlled by the battery I/F 339 of the autonomous movement control controller unit 330 will be described. In such a configuration, when the print control controller unit 300 uses the drive battery 361, the print control controller unit 300 transmits a power usage request to the autonomous movement control controller unit 330. The battery I/F 339 of the autonomous movement control controller unit 330 controls the drive battery 361 so as to supply the power to the print control controller unit 300 in accordance with the received power usage request.

FIG. 4 is a schematic diagram that illustrates an example of an operation direction of the image forming apparatus 101 shown in FIG. 1. The image forming apparatus 101 includes the traveling drive mechanism 410 shown in FIG. 4. The traveling drive mechanism 410, for example, drives and rotates two front wheels 411 and two rear wheels 412, respectively, and performs traveling by steering both the front wheels 411 and the rear wheels 412, or only the front wheels 411 (steering operations of both the front wheels 411 and the rear wheels 412, or only the front wheels 411). It should be noted that the traveling drive mechanism 410 is not limited to be a four-wheel drive configuration, and may be a two-wheel drive configuration. In addition, the traveling drive mechanism 410 may be a three-wheel drive configuration, or may be a multi-wheel configuration with five or more wheels, or may be a caterpillar type configuration.

In addition, the image forming apparatus 101 includes the image forming mechanism 420. The image forming mechanism 420 conveys a paper medium or the like to be printed in a sub-scanning direction 402, and performs printing processes such as exposure, development, transfer, and fixing. For example, in the case where the image forming mechanism 420 is an inkjet type, printing is performed by moving a printer head back and forth in a main scanning direction 403. It should be noted that in the present embodiment, it is assumed that a traveling direction 401 when traveling straight ahead and the sub-scanning direction 402 are parallel to each other and the main scanning direction 403 is perpendicular to the traveling direction 401.

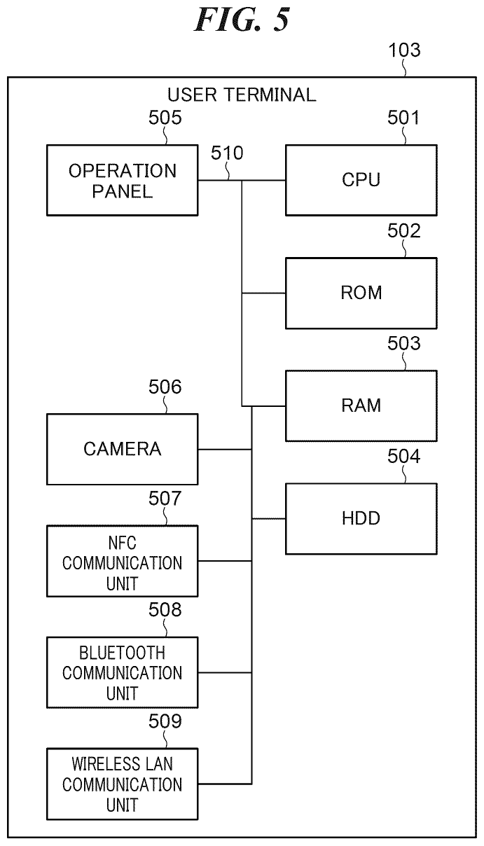

FIG. 5 is a block diagram that schematically illustrates a hardware configuration of the user terminal 103 shown in FIG. 1. It should be noted that the user terminal 103 in the present embodiment is assumed to be a client terminal such as a smartphone or a personal computer (a PC). As shown in FIG. 5, the user terminal 103 includes a CPU 501, a ROM 502, a RAM 503, a hard disk drive (an HDD) 504, an operation panel 505, a camera 506, an NFC communication unit 507, a Bluetooth communication unit 508, and a wireless LAN communication unit 509. The CPU 501, the ROM 502, the RAM 503, the HDD 504, the operation panel 505, the camera 506, the NFC communication unit 507, the Bluetooth communication unit 508, and the wireless LAN communication unit 509 are connected to each other via a bus 510.

The CPU 501 reads out a control program that has been stored in the ROM 502 and executes various kinds of processing for controlling the operations of the user terminal 103. The ROM 502 stores the control program. The RAM 503 is used as a main memory for the CPU 501 and a temporary storage area such as a working area for the CPU 501. The HDD 504 stores various types of data such as photographs and electronic documents.

The operation panel 505 has a touch panel function capable of detecting touch operations performed by the user, and displays various kinds of screens that are provided by the OS and an email sending application. The user is able to input desired operation instructions into the user terminal 103 by performing touch operations on the operation panel 505. It should be noted that the user terminal 103 may also be provided with hardware keys (not shown), and the user is also able to input operation instructions into the user terminal 103 by using these hardware keys. In addition, the user is also able to connect a keyboard, a mouse, etc. to the user terminal 103 to perform desired operations.

The camera 506 picks up an image in response to a user's instruction to pick up an image. The photograph (image) picked up by the camera 506 is stored in a predetermined area of the HDD 504. In addition, the user terminal 103 is capable of obtaining information from a QR code (registered trademark) that has been read by the camera 506 by using a program capable of analyzing a QR code. The user terminal 103 is capable of transmitting and receiving data to and from various kinds of peripheral devices via the NFC communication unit 507, the Bluetooth (registered trademark) communication unit 508, and the wireless LAN communication unit 509. It should be noted that the Bluetooth communication unit 508 may support Bluetooth Low Energy.

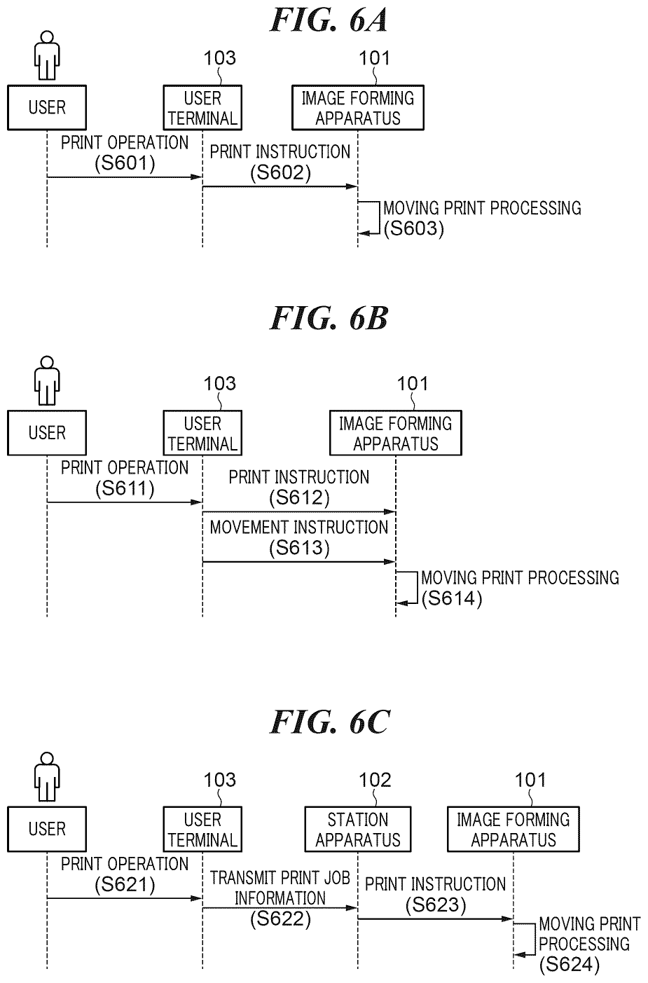

FIG. 6A, FIG. 6B, and FIG. 6C are sequence diagrams that illustrate the procedure of a printing operation performed by the image forming apparatus 101 shown in FIG. 1 in accordance with a print instruction received from the user terminal 103 shown in FIG. 1.

FIG. 6A shows the procedure of a printing operation when the user terminal 103 transmits a print instruction including moving destination information to the image forming apparatus 101.

As shown in FIG. 6A, first, the user performs a print operation with respect to the user terminal 103 (S601). This print operation is an operation for transmitting a print instruction from the user terminal 103 to the image forming apparatus 101, and also includes an operation for designating a moving destination of the image forming apparatus 101.

Next, the user terminal 103 transmits a print instruction to the image forming apparatus 101 in accordance with the accepted print operation (S602). This print instruction includes print setting information to be used for the print processing performed by the image forming apparatus 101 and moving destination information indicating the moving destination of the image forming apparatus 101.

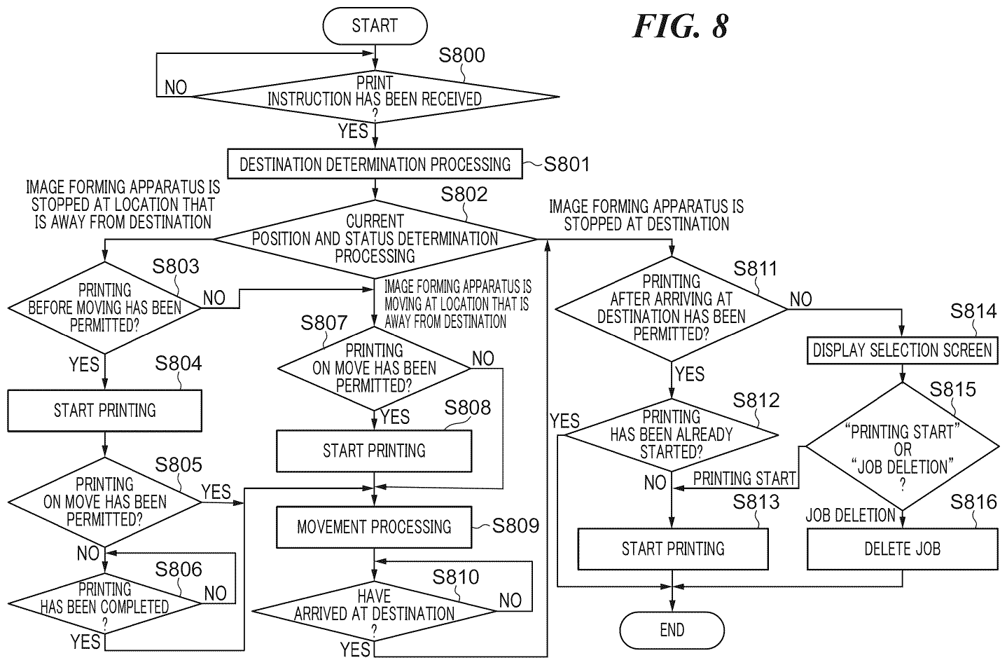

Next, the image forming apparatus 101 executes a moving print processing shown in FIG. 8, which will be described below, based on the received print instruction (S603), and ends the printing operation shown in FIG. 6A.

FIG. 6B shows the procedure of a printing operation when the user terminal 103 transmits a print instruction and moving destination information to the image forming apparatus 101 as separate pieces of data.

As shown in FIG. 6B, first, the user performs a print operation with respect to the user terminal 103 (S611). This print operation, like S601 that has been described above, is an operation for transmitting a print instruction from the user terminal 103 to the image forming apparatus 101, and also includes an operation for designating a moving destination of the image forming apparatus 101.

Next, the user terminal 103 transmits a print instruction to the image forming apparatus 101 in accordance with the accepted print operation (S612). This print instruction includes the print setting information to be used for the print processing performed by the image forming apparatus 101, but does not include the moving destination information indicating the moving destination of the image forming apparatus 101.

Furthermore, the user terminal 103 transmits the moving destination information to the image forming apparatus 101 (S613).

Next, the image forming apparatus 101 executes the moving print processing shown in FIG. 8, which will be described below, based on the received print instruction and the received moving destination information (S614), and ends the printing operation shown in FIG. 6B.

FIG. 6C shows the procedure of a printing operation when the user terminal 103 transmits a print instruction including moving destination information to the station apparatus 102 to which the image forming apparatus 101 is connected.

As shown in FIG. 6C, first, the user performs a print operation with respect to the user terminal 103 (S621). This print operation is an operation for transmitting a print instruction from the user terminal 103 to the station apparatus 102 to which the image forming apparatus 101 is connected, and also includes an operation for designating a moving destination of the image forming apparatus 101.

Next, the user terminal 103 transmits print job information to the station apparatus 102 in accordance with the accepted print operation (S622). This print job information includes the print setting information to be used for the print processing performed by the image forming apparatus 101 and the moving destination information indicating the moving destination of the image forming apparatus 101.

Next, the station apparatus 102 transmits a print instruction, which has been generated based on the received print job information, to the image forming apparatus 101 (S623). This print instruction includes the print setting information to be used for the print processing performed by the image forming apparatus 101 and the moving destination information indicating the moving destination of the image forming apparatus 101.

Next, the image forming apparatus 101 executes the moving print processing shown in FIG. 8, which will be described below, based on the received print instruction (S623), and ends the printing operation shown in FIG. 6C.

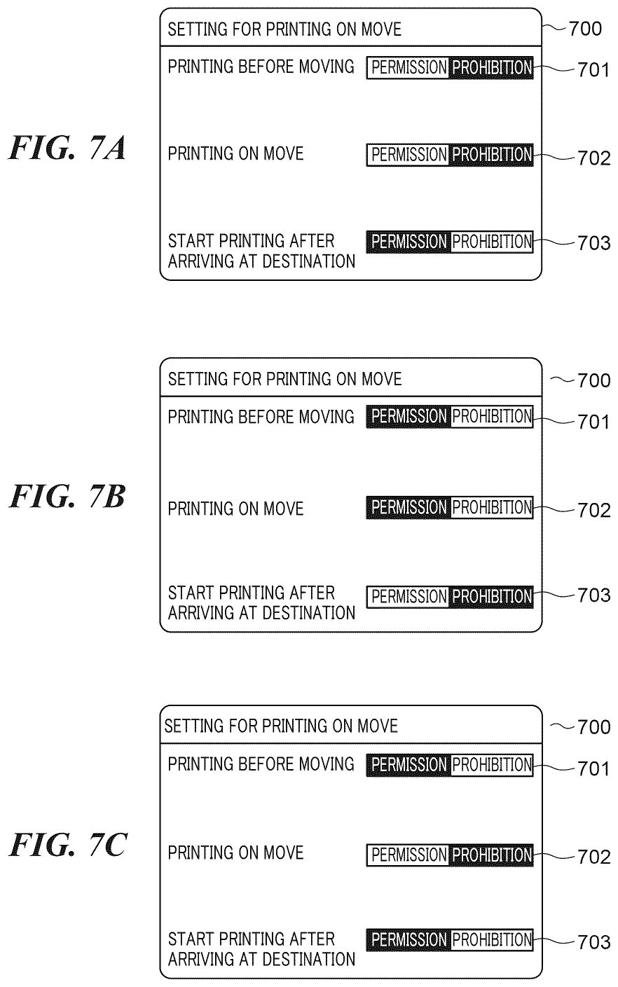

FIG. 7A, FIG. 7B, and FIG. 7C are diagrams that illustrate examples of a setting screen 700 displayed on the operation unit 321 shown in FIG. 3. In the present embodiment, the user is able to set whether or not to permit printing at a predetermined timing related to the movement of the image forming apparatus 101 on the setting screen 700 of FIG. 7A displayed on the operation unit 321 of the image forming apparatus 101.

The setting screen 700 is configured to include a setting item 701, a setting item 702, and a setting item 703. The setting item 701 is an item for setting whether or not to permit printing before moving. Before moving refers to, for example, before the image forming apparatus 101, which is stopped at a location that is away from a destination, starts moving to the destination. The setting item 702 is an item for setting whether or not to permit printing while the image forming apparatus 101 is moving (printing on the move). The setting item 703 is an item for setting whether or not to permit printing after arriving at the destination. After arriving at the destination refers to, for example, a case where the image forming apparatus 101 has reached the destination, or a case where the image forming apparatus 101 has already stopped at the destination when the image forming apparatus 101 receives a print instruction.

FIG. 7A shows a setting example that places the importance on security. In the case where the importance is placed on security, it is preferable to start printing in the case where the user is near the image forming apparatus 101, that is, it is preferable to start printing at a time point when the image forming apparatus 101 has reached the destination, so as to be capable of preventing a third party from taking out the printed matter. In FIG. 7A which is the setting example that places the importance on security, only the setting item 703 has been set to “permission”, and both the setting item 701 and the setting item 702 have been set to “prohibition”. With such a setting, since printing is executed only in the case where the image forming apparatus 101 is near the user, it becomes possible to prevent a third party from taking out the printed matter.

FIG. 7B shows a setting example that places the importance on quietness (low noise). In the case where the importance is placed on quietness (low noise), it is necessary to prevent printing noise from being generated around the user, and it is preferable to start printing in the case where the user is not near the image forming apparatus 101, that is, it is preferable to start printing before the image forming apparatus 101 moves to the destination, or while the image forming apparatus 101 is moving to the destination. In FIG. 7B which is the setting example that places the importance on quietness (low noise), both the setting item 701 and the setting item 702 have been set to “permission”, and only the setting item 703 has been set to “prohibition”. With such a setting, since printing is executed only in the case where the image forming apparatus 101 is not near the user, it becomes possible to prevent the printing noise from being generated around the user.

FIG. 7C shows a setting example that places the importance on print quality. In the case where the importance is placed on print quality, in order to prevent the occurrence of printing defects such as line streaks and blurring caused by the occurrence of shaking or acceleration caused by the movement (traveling) of the image forming apparatus 101, it is preferable to start printing at a timing when the image forming apparatus 101 is not moving. In FIG. 7C which is the setting example that places the importance on print quality, both the setting item 701 and the setting item 703, which are timings when the image forming apparatus 101 is not moving, have been set to “permission”, and only the setting item 702 has been set to “prohibition”. With such a setting, since printing is executed only at the timing when the image forming apparatus 101 is not moving, it becomes possible to prevent the occurrence of printing defects caused by the occurrence of shaking or acceleration caused by the movement (traveling) of the image forming apparatus 101.

FIG. 8 is a flowchart that illustrates the procedure of the moving print processing executed by the image forming apparatus 101 shown in FIG. 1. The moving print processing shown in FIG. 8 is realized by the CPU 301 executing a program that has been loaded from the ROM 303 or the like into the RAM 302. In the present embodiment, it is assumed that the user has previously performed setting of the setting screen 700 before the moving print processing shown in FIG. 8 is executed, and that setting values of the setting screen 700 have been retained in the RAM 302 or the like. It should be noted that all of the processes of S603, S614, and S624 that have been described above are the moving print processing shown in FIG. 8.

As shown in FIG. 8, first, the CPU 301 waits until a print instruction is received. When a print instruction is received (YES in S800), the CPU 301 performs a destination determination processing (S801). Specifically, the CPU 301 issues an instruction for determining a destination to the CPU 331. Upon receiving the instruction for determining a destination, the CPU 331 determines a destination based on the moving destination information included in the print instruction or the moving destination information received together with the print instruction, and the map information 900 shown in FIG. 9 that has been stored in the storage 334.

FIG. 9 is a diagram that illustrates an example of the map information 900 that has been stored in the storage 334 shown in FIG. 3. In FIG. 9, an area surrounded by a dotted line indicates a range within which the image forming apparatus 101 is capable of traveling, and the image forming apparatus 101 is capable of self-traveling (traveling independently) only within this range. Areas surrounded by straight lines connecting white circles (open circles) indicate obstacles, and the image forming apparatus 101 is not capable of entering inside the areas. Black circles (filled circles) represent seat information of users who are able to perform print operations, and names of the users and their position information have been recorded. As described above with reference to FIG. 3, the image forming apparatus 101 includes the position detector 341, and in the map information 900, coordinate information of each position has been recorded in the same coordinate system as that used by the position detector 341. As a result, since the position information of the user who has performed the print operation is capable of being identified on the map information 900, it is possible to determine a route from the current position of the image forming apparatus 101 at that time point to the position of the user who has performed the print operation while avoiding the obstacles. This route enables the image forming apparatus 101 to move to the destination, that is, to the location of the user who has performed the print operation.

Next, the CPU 301 performs a processing of determining the current position and status of the image forming apparatus 101 (S802). Specifically, the CPU 301 issues, to the CPU 331, an instruction to determine the current position and status of the image forming apparatus 101. Upon receiving the instruction to determine the current position and status of the image forming apparatus 101, the CPU 331 determines the current position and status of the image forming apparatus 101 and notifies the CPU 301 of the determination result.

In the case of being determined in S802 that the image forming apparatus 101 is stopped at a location that is away from the destination, the CPU 301 determines whether or not printing before moving has been permitted based on the setting values of the setting screen 700 that have been retained in the RAM 302 or the like (S803). In the case of being determined that printing before moving has not been permitted (NO in S803), the moving print processing shown in FIG. 8 proceeds to S807, which will be described below.

In the case of being determined that printing before moving has been permitted (YES in S803), the CPU 301 starts printing (S804). Next, the CPU 301 determines whether or not printing on the move has been permitted based on the setting values of the setting screen 700 that have been retained in the RAM 302 or the like (S805). In the case of being determined that printing on the move has been permitted (YES in S805), the moving print processing shown in FIG. 8 proceeds to a movement processing of S809. On the other hand, in the case of being determined that printing on the move has not been permitted (NO in S805), the CPU 301 determines whether or not printing has been completed (S806). The CPU 301 waits until printing is completed. When printing is completed (YES in S806), the moving print processing shown in FIG. 8 proceeds to the movement processing of S809.

In the case of being determined in S802 that the image forming apparatus 101 is moving at a location that is away from the destination, the CPU 301 determines whether or not printing on the move has been permitted based on the setting values of the setting screen 700 that have been retained in the RAM 302 or the like (S807). In the case of being determined that printing on the move has not been permitted (NO in S807), the CPU 301 does not start printing, and proceeds to the movement processing of S809, which will be described below. On the other hand, in the case of being determined that printing on the move has been permitted (YES in S807), the CPU 301 starts printing (S808).

Next, the CPU 301 performs the movement processing (S809). Specifically, the CPU 301 issues, to the CPU 331, an instruction to move to the destination. Upon receiving the instruction to move to the destination, the CPU 331 starts control to move the image forming apparatus 101 to the destination.

Next, the CPU 301 determines whether or not the image forming apparatus 101 has arrived at the destination (S810). For example, in the case where the CPU 301 has received, from the CPU 331, a notification indicating that the image forming apparatus 101 has arrived at the destination, the CPU 301 determines that the image forming apparatus 101 has arrived at the destination, and otherwise, the CPU 301 determines that the image forming apparatus 101 has not arrived at the destination. The CPU 301 waits until it determines that the image forming apparatus 101 has arrived at the destination. If it is determined that the image forming apparatus 101 has arrived at the destination (YES in S810), the moving print processing shown in FIG. 8 proceeds to S811.

In the case of being determined in S802 that the image forming apparatus 101 is stopped at the destination, the CPU 301 determines whether or not printing after arriving at the destination has been permitted based on the setting values of the setting screen 700 that have been retained in the RAM 302 or the like (S811).

In the case of being determined in S811 that printing after arriving at the destination has been permitted, the CPU 301 determines whether or not printing corresponding to the print instruction received in S800 has been already started (S812). In the case of being determined that printing corresponding to the print instruction received in S800 has been already started (YES in S812), the moving print processing shown in FIG. 8 ends. On the other hand, in the case of being determined that printing corresponding to the print instruction received in S800 has not been started (NO in S812), the CPU 301 starts printing (S813). After that, the moving print processing shown in FIG. 8 ends.

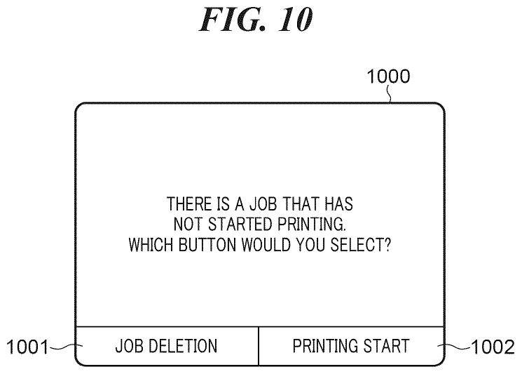

In the case of being determined in S811 that printing after arriving at the destination has not been permitted, the CPU 301 causes the operation unit 321 to display a selection screen 1000 shown in FIG. 10 (S814). The selection screen 1000 includes a job deletion button 1001 and a printing start button 1002. When the user selects either the job deletion button 1001 or the printing start button 1002 on the selection screen 1000, the CPU 301 determines whether the button selected by the user is the job deletion button 1001 or the printing start button 1002 (S815).

In the case of being determined in S815 that the button selected by the user is the job deletion button 1001, the CPU 301 deletes the job corresponding to the print instruction received in S800 (S816). After that, the moving print processing shown in FIG. 8 ends.

In the case of being determined in S815 that the button selected by the user is the printing start button 1002, the moving print processing shown in FIG. 8 proceeds to S813, where printing corresponding to the print instruction received in S800 is started. After that, the moving print processing shown in FIG. 8 ends.

According to the above-described embodiment, the execution of printing is controlled based on the setting values of the setting screen 700 that have been set by the user. The setting values of the setting screen 700 are setting values that indicate whether or not to permit printing at the predetermined timing related to the movement of the image forming apparatus 101. As a result, it is possible to control the execution of printing during the movement of the image forming apparatus 101, which can cause printing defects, based on the setting values of the setting screen 700 that have been set by the user. As a result, it is possible to prevent the occurrence of printing defects caused by the occurrence of shaking or acceleration caused by the movement (traveling) of the image forming apparatus 101.

In addition, in the above-described embodiment, the predetermined timing is when the image forming apparatus 101 is moving. As a result, it is possible to perform control so that printing is not performed while the image forming apparatus 101 is moving since the movement of the image forming apparatus 101 may cause printing defects.

In addition, in the above-described embodiment, the predetermined timing is before the image forming apparatus 101 moves. As a result, for example, by causing to prohibit the execution of printing before the image forming apparatus 101 moves, it is possible to prevent a third party from taking out the printed matter.

In addition, in the above-described embodiment, the predetermined timing is after the image forming apparatus 101 arrives at the destination. As a result, for example, by causing to prohibit the execution of printing after the image forming apparatus 101 arrives at the destination, it is possible to prevent the printing noise from being generated around the user.

In addition, in the above-described embodiment, in the case where printing after arriving at the destination has been set to “prohibition” on the setting screen 700 and the image forming apparatus 101 has arrived at the destination, the selection screen 1000 is displayed on the operation unit 321. As a result, it is possible to reflect the user's intention in whether to start printing corresponding to the print instruction received in S800 or to delete the job corresponding to the print instruction received in S800.

It should be noted that in the present embodiment, the configuration, in which the setting screen 700 is displayed on the operation unit 321, has been described, but the present disclosure is not limited to this configuration. For example, the setting screen 700 may be displayed on another apparatus different from the image forming apparatus 101, such as the operation panel 505 of the user terminal 103. In other words, the setting of the setting screen 700 may be performed on an apparatus other than the image forming apparatus 101. In such a configuration, for example, before making the determinations of S803, S807, and S811 that have been described above, the image forming apparatus 101 obtains the setting values of the setting screen 700 from another apparatus such as the user terminal 103, and retains the obtained setting values in the RAM 302 or the like. Even with such a configuration, the same effects as those of the above-described embodiment can be achieved.

In addition, in the present embodiment, the configuration, in which the image forming apparatus 101 includes the image forming mechanism 420 and the traveling drive mechanism 410, has been described, but the present disclosure is not limited to this configuration. For example, a configuration may be adopted in which the image forming apparatus 101 is separate from the traveling drive mechanism 410, that is, a configuration may be adopted in which the image forming apparatus 101 does not include the traveling drive mechanism 410, and a moving apparatus that includes the traveling drive mechanism 410 moves with the image forming apparatus 101 placed thereon. In such a configuration, the image forming apparatus 101 obtains various kinds of information by performing wired or wireless communication with the moving apparatus, and executes the moving print processing shown in FIG. 8 that has been described above. Even with such a configuration, the same effects as those of the above-described embodiment can be achieved.

According to the present disclosure, it is possible to prevent the occurrence of printing defects caused by the occurrence of shaking or acceleration caused by the movement of the image forming apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-160790, filed Sep. 18, 2024, which is hereby incorporated by reference herein in its entirety.

What is claimed is:

1. An image forming apparatus that is capable of being moved by a moving mechanism to a destination designated by a user, the image forming apparatus comprising:
at least one processor; and
a memory coupled to the processor storing instructions that, when executed by the processor, cause the processor to function as:
a printing unit that executes a print processing that generates a printed matter;
a retaining unit that retains a setting set by the user, the setting indicating whether or not to permit execution of the print processing at a predetermined timing related to movement by the moving mechanism; and
a control unit that controls the execution of the print processing based on the setting.

2. The image forming apparatus according to claim 1, wherein
the predetermined timing is during the movement by the moving mechanism.

3. The image forming apparatus according to claim 1, wherein
the predetermined timing is before the movement by the moving mechanism starts.

4. The image forming apparatus according to claim 1, wherein
the predetermined timing is after arriving at the destination.

5. The image forming apparatus according to claim 4, wherein
the processor is caused to further function as a display control unit that, in a case where a setting for prohibiting the execution of the print processing after arriving at the destination is retained and the image forming apparatus has arrived at the destination by the moving mechanism, causes a display unit of the image forming apparatus to display a screen that allows the user to select either starting the print processing or deleting a print job corresponding to the print processing.

6. The image forming apparatus according to claim 1, wherein
the processor is caused to further function as a display control unit that causes a display unit of the image forming apparatus to display a screen for allowing the user to set whether or not to permit the execution of the print processing at the predetermined timing.

7. The image forming apparatus according to claim 1, wherein
the user operates another apparatus different from the image forming apparatus to set the setting, and
the retaining unit retains the setting that has been transmitted from the another apparatus.

8. The image forming apparatus according to claim 1, wherein
the image forming apparatus comprises the moving mechanism.

9. The image forming apparatus according to claim 1, wherein
the image forming apparatus is separate from the moving mechanism.

10. A control method for an image forming apparatus that is capable of being moved by a moving mechanism to a destination designated by a user, the control method comprising:
a printing step of executing a print processing that generates a printed matter;
a retaining step of retaining a setting set by the user, the setting indicating whether or not to permit execution of the print processing at a predetermined timing related to movement by the moving mechanism; and
a control step of controlling the execution of the print processing based on the setting.

11. A non-transitory computer-readable storage medium storing a program for causing a computer to execute a control method for an image forming apparatus that is capable of being moved by a moving mechanism to a destination designated by a user, the control method comprising:
a printing step of executing a print processing that generates a printed matter;
a retaining step of retaining a setting set by the user, the setting indicating whether or not to permit execution of the print processing at a predetermined timing related to movement by the moving mechanism; and
a control step of controlling the execution of the print processing based on the setting.
